(19) United States
(12) Patent Application Publication
(10) Pub. No.: US 2005/0199273 A1
(43) Pub. Date: Sep. 15, 2005

(54) Filter device

(75) Inventor: Michael Rosenbauer, Reimlingen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/068,644

(22) Filed: Feb. 28, 2005

(30) Foreign Application Priority Data
Aug. 28, 2002 (DE) 102 39 495.4
Aug. 20, 2003 (WO) PCT/EP03/09242

(51) Int. Cl. B08B 3/00

(52) U.S. Cl. 134/56 D

(57) ABSTRACT

There is provided a filter device that enables less frequent manual or self cleaning of the filter surface. The filter is particularly suitable for an aquiferous domestic appliance, such as a dishwashing machine, in which the cleaning effect occurring with alternating pumping is further increased, such that manual cleaning of the filter surface need take place less often, or, respectively, self-cleaning of the filter surface occurs.

The invention relates to a filter device comprising at least one filter body with a filter surface. Such filters are often arranged in aquiferous domestic appliances, in particular in dishwashing machines.

With conventional filter devices, e.g. for dishwashing machines, a filter body is provided with one or more filter surfaces, whereby the filter surface is preferably made from materials which are substantially corrosion-resistant to constituents dissolved in a selected cleaning liquid. For this reason the filter surfaces e.g. in conventional dishwashing machines are made either of stainless steel or a high-quality synthetic material, where the surface quality of the filter surface is significant also, in addition to the choice of material. In practice it has been shown that small dirt particles and/or bacteria can lodge in furrows and surface roughness where there is a coarse surface quality, so that a filter surface appears unclean from both the hygienic and optical viewpoints. With dishwashing machines it is known (e.g. see DE-3114 663 A1) to reverse the direction of flow through the filter surface at least for a brief time, so-called alternating pumping, resulting in certain self-cleaning of the filter devices, though manual cleaning of the filter surfaces is still required from time to time.

The object of the present invention is therefore to provide a filter device, which enables less frequent manual cleaning of the filter surface or respectively self-cleaning of the filter surface; the object is also to provide an aquiferous domestic appliance, in particular a dishwashing machine, in which the cleaning effect occurring with alternating pumping is further increased, such that, as already mentioned, manual cleaning of the filter surface need take place less often, or respectively self-cleaning of the filter surface occurs.

This task for the filter device is solved by the inventive filter device having the characteristics as per Claim 1. This task is solved for the aquiferous domestic appliance and for the dishwashing machine according to the characteristics of the further independent claims. Advantageous further developments of the present invention are characterised in the independent claims.

The inventive filter device has an adhesion-reducing layer at least on the side of the filter surface facing the material to be filtered.

The advantage of the inventive filter device is that both particles and material to be filtered with dissolved constituents now find it difficult to adhere to the filter surface, so that dirt particles and/or bacteria and also constituents dissolved in material to be filtered do not adhere to the filter surface, thus enabling manual cleaning of the filter surface or respectively self-cleaning of the filter surface to take place less often.

According to an advantageous embodiment of the invention there is provided on both sides of the filter surfaces an adhesion-reducing layer, so that adhesion of dirt particles and/or bacteria is substantially reduced on both sides of the filter surface also with the abovementioned alternating pumps.

In a particularly advantageous manner the adhesion-reducing layer essentially consists of a so-called Diamond-Light-Carbon substance.

The abovementioned advantages of the inventive filter device are naturally used in the inventive arrangement of at least one of the abovedescribed inventive filter devices in an aquiferous domestic appliance as well as in an inventive dishwashing machine.

By way of advantage with the inventive arrangement of one of the abovedescribed inventive filter devices in a dishwashing machine the filter surface is provided with an adhesion-reducing layer at least on the side facing a rinse container of the dishwashing machine.

The advantage of the inventive filter device is that both particles and material to be filtered with dissolved constituents now find it difficult to adhere to the filter surfaces, so that in particular with use of a Diamond-Light-Carbon coating dirt particles do not adhere to the filter surface and with aquiferous domestic appliances and dishwashing machines constituents dissolved in the selected cleaning liquid do not adhere to the filter surface. With the abovedescribed alternating pumping a particularly high self-cleaning effect is achieved when the inventive filter device is utilised.

The adhesion-reducing layer can already be applied to the metal foils, from which the filter surfaces are made. Yet it is also possible to effect coating with Diamond-Light-Carbon immediately after the filter surfaces are created. There is the advantage with retro-coating that the drop in surface quality resulting from punching out the filter apertures can be substantially compensated, since the Diamond-Light-Carbon coating can also be applied in the cross-sectional spaces of the filter surface opening. On the other hand coating the sheets in advance can be more economical prior to creating the filter holes.

1-6. (canceled)

7. A filter device, comprising:at least one filter body with a filter surface, the filter body being operable to filter material that moves through the filter surface from one side thereof that faces the material to another side thereof and the filter surface having an adhesion-reducing layer at least on the side of the filter surface facing the material to be filtered.

8. The filter device as claimed in claim 7, wherein both the one side and the another side of the filter surface are provided with an adhesion-reducing layer.

9. The filter device as claimed in claim 7, wherein the adhesion-reducing layer comprises diamond light carbon.

10. An aquiferous domestic appliance, comprising: a device for containing aquiferous material to be filtered; and at least one filter body with a filter surface, the filter body being operable to filter aquiferous material that moves through the filter surface from one side thereof that faces the aquiferous material to be filtered to another side thereof and the filter surface having an adhesion-reducing layer at least on the side of the filter surface facing the aquiferous material to be filtered.

11. A dishwashing machine, comprising:
a device for containing aquiferous material to be filtered; and
at least one filter body with a filter surface, the filter body being operable to filter aquiferous material that moves through the filter surface from one side thereof that faces the aquiferous material to another side thereof and the filter surface having an adhesion-reducing layer at least on the side of the filter surface facing the aquiferous material to be filtered.

12. The dishwashing machine as claimed in claim 11, wherein the device for containing aquiferous material to be filtered is a rinse container and the filter surface is provided with an adhesion-reducing layer at least on the side facing the rinse container of the dishwashing machine.
